(19) United States
(12) Patent Application Publication
(10) Pub. No.: US 2003/0160822 A1
(43) Pub. Date: Aug. 28, 2003

(54) System and method for creating graphical user interfaces

(75) Inventors: Steven M. Belz, Pittsford, NY (US); Anthony L. Tintera, Hamlin, NY (US); Larry W. Wilkinson, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/368,171

(22) Filed: Feb. 18, 2003

Related U.S. Application Data
(60) Provisional application No. 60/358,815, filed on Feb. 22, 2002.

(51) Int. Cl. G09G 5/00

(52) U.S. Cl. 345/762

(57) ABSTRACT

A system for creating a graphical user interface for a platform having a display and one or more operator input devices, comprising: a user interface design tool for producing a file system stream describing the user interface and resources, the user interface design tool including a platform definition defining the capabilities of the platform including descriptions of user interface widgets and platform adapters, a plurality of resources containing descriptions of graphical components used by the widgets, a layout manager for producing a description of a layout of user interface widgets on the graphical user interface, a design editor for producing a description of the characteristics of the user interface widgets defined by the layout manager and the resources and how widgets bind with each other and with the platform adapters, the binding involving binding data representations within a widget to a data representation in another widget or adapter, and binding events within a widget to events within another widget or adapter, and a platform export module for creating the file system stream using the descriptions from the layout manager and the design editor and the graphical components from the resources; and a runtime engine located in the platform for rendering the graphical user interface from the file system stream, the runtime engine including: a loader for receiving the file stream and creating the widgets and the adapters needed to produce the graphical user interface and binding the widgets to each other ant to the platform adapters, and a window management engine for passing input from the operator input devices to the widgets.

### CROSS REFERENCE TO RELATED APPLICATIONS

This is a 111A application of Provisional application Serial No. 60/358,815, filed Feb. 22, 2002 by Belz et al., entitled A Dynamic Interface Creation System Supporting Extensible Runtime Framework For Developing Prototype And Implementation Of The Final Product Interface For Embedded Systems.

### FIELD OF THE INVENTION

The present invention relates to graphical user interface design, and more particularly to systems for creating graphical user interfaces.

### BACKGROUND OF THE INVENTION

The development of Graphical User Interfaces (GUIs) in general, and embedded GUIs in particular, has always been time consuming and labor intensive. In addition, the people with the skills to develop the code for the GUIs are not equipped to deal with the Human Computer Interaction (HCI) issues associated with creating great user interfaces. In general, the GUIs are designed by HCI experts and coded by software developers. The designers then pass the design to the programmers who attempt to fit the interface design to the constraints of the current target platform. To complicate matters, seemingly trivial changes in the user interface (like the repositioning of a few widgets) could result in re-coding of large sections of the code-base and the need to recompile of the entire GUI. As commonly used in the computer software field, a widget refers to an element of a graphical user interface (GUI) that displays information or provides a specific way for a user to interact with the operating system and application. Widgets include icons, pull-down menus, buttons, selection boxes, progress indicators, on-off checkmarks, scroll bars, windows, window edges (that let you resize the window), toggle buttons, forms, and many other devices for displaying information and for inviting, accepting, and responding to user actions. A widget class is used as an abstract class definition, depicting the symbols, their types, default values (if desired), and/or comments associated with the contained widgets.

Several technologies (e.g., HTML and other declarative languages) attempt to simplify the development of user interfaces. These languages provide ease of use but lack the power of imperative languages (C/C++, Java) that allow for complex interactions. In addition, these technologies still face some of the same issues as traditional GUIs when faced with large scale changes in the user interface. The change process is time consuming to implement and test and does not allow for rapid prototyping.

There is a need, therefore, for an improved system for creating a graphical user interface that avoids the problems noted above.

### SUMMARY OF THE INVENTION

This need is met according to the present invention by providing a system for creating a graphical user interface for a platform having a display and one or more operator input devices, comprising: a user interface design tool for producing a file system stream describing the user interface and its resources, the user interface design tool including a platform definition defining the capabilities of the platform including descriptions of user interface widgets and platform adapters, a plurality of resources containing descriptions of graphical components used by the widgets, a layout manager for producing a description of a layout of user interface widgets on the graphical user interface, a design editor for producing a description of the characteristics of the user interface widgets defined by the layout manager and the resources and how widgets bind with each other and with the platform adapters, the binding involving binding data representations within a widget to a data representation in another widget or adapter, and binding events within a widget to events within another widget or adapter, and a platform export module for creating the file system stream using the descriptions from the layout manager and the design editor and the graphical components from the resources; and a runtime engine located in the platform for rendering the graphical user interface from the file system stream, the runtime engine including: a loader for receiving the file stream and creating the widgets and the adapters needed to produce the graphical user interface and binding the widgets to each other and to the platform adapters, and a window management engine for passing input from the operator input devices to the widgets.

### ADVANTAGES

The present invention has the advantage that it brings the ease of use of declarative languages and the power of imperative languages to the development of GUIs for embedded systems in general and digital cameras in particular.

### BRIEF DESCRIPTION OF THE DRAWINGS

FIG. 1 is a is a schematic diagram contrasting the prior art method of creating a Graphical User Interface (GUI) with the method of the present invention;

FIG. 2 is a schematic diagram of the user interface design tool (UiMagi) and a platform for implementing the Graphical User Interface (GUI) provided by UiMagi;

FIG. 3 is a schematic diagram showing one implementation of a Graphical User Interface (GUI) runtime engine (Chimera);

FIG. 4 is a schematic diagram showing a generic architecture of a Graphical User Interface (GUI) runtime engine;

FIG. 5 is an example implementation of the Chimera Definition File (CDF) format for the Graphical User Interface (GUI) according to the present invention;

FIG. 6 is an initialization sequence diagram for a Graphical User Interface (GUI) interpreter according to the present invention;

FIG. 7 is a loading sequence diagram for loading the Graphical User Interface (GUI) into the interface interpreter;

FIG. 8 is an initialization sequence diagram for an applet that generates a screen within the Graphical User Interface (GUI) definition file; and

FIG. 9 is a sequence diagram showing the binding of events and elements within an applet;

### DETAILED DESCRIPTION OF THE INVENTION

The system for designing a user interface according to the present invention includes a user interface design tool (called UiMagi) that uses a simple script-like language for producing a file system stream that describes the graphic user interface and a runtime engine (called Chimera) that employs the file system stream to display the graphic user interface.

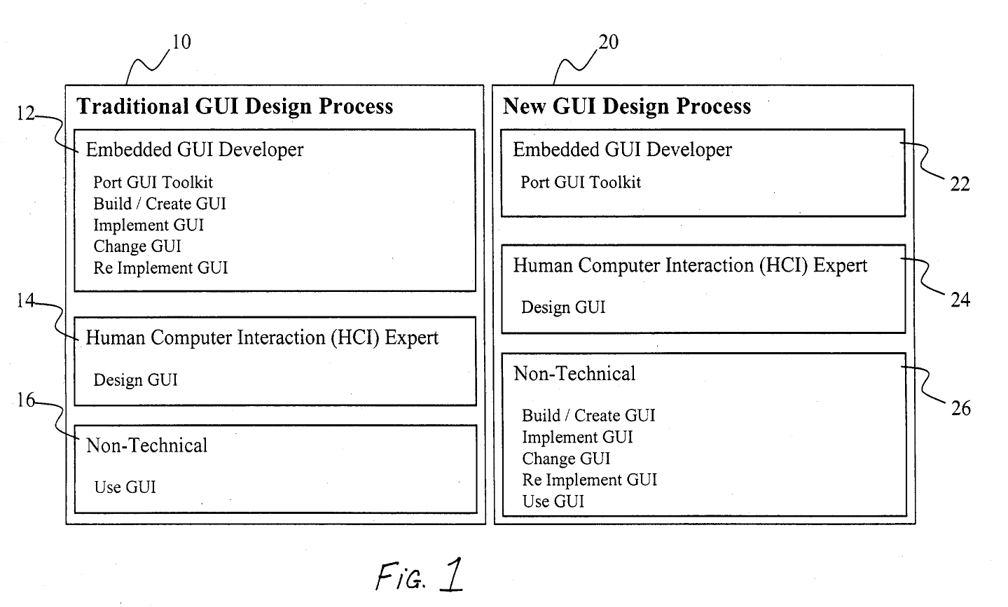

To simplify the process of Graphical User Interface (GUI) development, Chimera is used in conjunction with UiMagi hosted on a desktop platform. UiMagi allows human computer interaction experts to create rapid prototypes for user interface testing. The key aspect of Chimera is that the same tool will be employed to create the final production GUI when it is deployed on the target platform. This allows the use of a different process for the development of user interfaces that shortens development cycles and results in robust user interfaces. FIG. 1 illustrates Chimera approach to GUI development compared with a more traditional process. As shown in FIG. 1, the traditional approach 10 involves the role 12 of the GUI developer including porting a GUI toolkit to enable a graphic engine to run on a specific device, building or creating the GUI, implementing the GUI, changing the GUI, and re-implementing the GUI; the role 14 of the human computer interaction expert in designing the GUI; and the role 16 of non-technical persons whose only role is to use the interface. In contrast, the GUI design approach 20 of the present invention reduces the role 22 of the GUI developer while increasing the capability 26 of the non-technical persons to include building or creating a GUI, implementing the GUI, changing the GUI, and re-implementing the GUI.

A glossary of terminology pertaining to Chimera system is contained in Chimera Dictionary in Appendix A. The goals of the architecture are to provide a Chimera specific user interface development environment that will allow for the rapid prototype and implementation of the final product GUI for embedded systems and to provide an extensible runtime framework to allow developers to build a robust and feature-rich runtime engine, while allowing the embedded developer to be in full control of features, functionality and implementation.

Chimera Architecture supports Platform Independence. Chimera GUIs are developed on a host platform using UiMagi and are then deployed on any platform to which Chimera is ported. To allow this, Chimera and its supporting software modules are portable to multiple platforms. Chimera architecture allows the creation of user interfaces whose presentation and behavior can be easily changed without changing the runtime engine. To accomplish this the runtime engine provides mechanisms to create dynamically bound user interface elements to other user interface elements and to the platform itself. Chimera can be deployed on memory and processing power constrained hardware platforms. It is also extensible to accommodate richer functionality on future device platforms.

As Chimera is capable of running on a variety of different platforms, Chimera GUI Definition software takes into account the characteristics of a specific platform when creating GUIs. To this end, the architecture provides a means to describe these platforms to UiMagi. This allows device platform designers to specify the features, constraints and limitations of their particular platform.

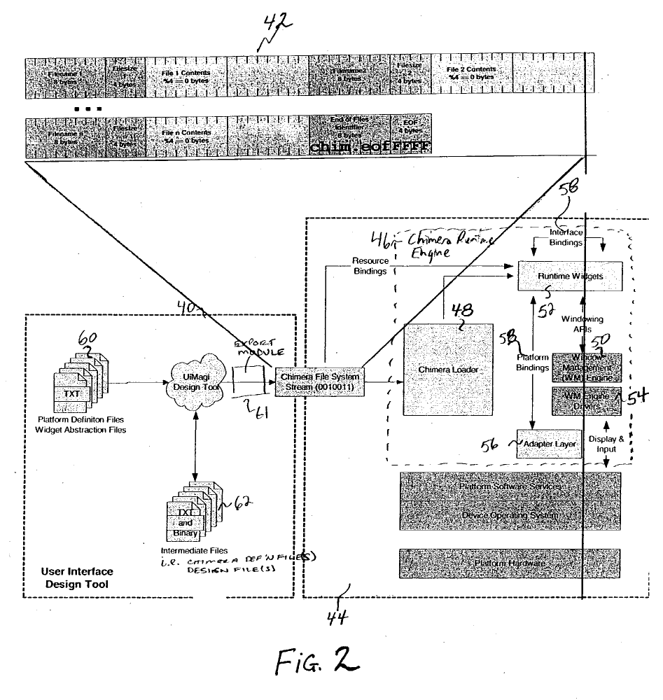

UiMagi of the present invention includes several components some of which are host based and some of which are deployed on the target platform. FIG. 2 illustrates the GUI design system components while tying them together in a typical GUI design process. As shown in FIG. 2, UiMagi 40 creates a stream 42 that is transferred to the device platform 44 running a Chimera runtime engine 46. This Chimera runtime engine 46 provides a loader 48 capable of translating the stream 42 of information into a dynamically created interface, which is visible to a user. The interface is created by the use of a window management engine 50, which provides mechanisms to create layers of graphical elements, which are referred to as Runtime Widgets 52. The window management engine 50 accesses platform hardware events and display surface through drivers 54 that are provided.

An adapter layer 56 is provided in conjunction with Chimera 46 in such a way that it can be bound to the user-interface as encoded in the interface definition files. Widgets 52 can also bind to resources in Chimera file system stream as well as other widgets, again as specified by the interface definition files. Chimera loader 48 is responsible for switching interfaces, providing access to resources available in Chimera file system stream 42 and binding data and events using Chimera binding mechanisms 58.

UiMagi 40 is a host-based tool that allows a non-technical person to act as a GUI designer to create embedded GUIs graphically on a host computer. The design can then be exported in a platform specific format to be deployed on the target platform 44 without further involvement from the embedded software developer. UiMagi 40 uses Platform Definition Files (PDF) 60 to tailor the editing process for a specific target system. PDFs 60 describe the characteristics of a particular target device using a simple, ASCII text based language called the Platform Definition Language (by, not shown). The PDF is maintained by the embedded GUI developer 22 (see FIG. 1), and thus guarantees that the resulting Chimera file system stream 42 from UiMagi 40 will be compatible with the device platform 44 when the GUI is rendered.

A Platform Export Module 61 (PEM) converts platform independent designs to a platform specific format. UiMagi is very modular and only contains the core functionality needed to provide graphical editing of user interfaces. It utilizes this PEM to generate platform specific format that can be used by the Chimera runtime engine 46 on the device platform.

Chimera runtime engine 46 uses Chimera file system stream 42 to dynamically instantiate and present the user interfaces created with UiMagi. Chimera file system stream 42 stores a variety of resources, which include the Chimera Definition Files (CDFs) that describe individual interfaces.

UiMagi generates the CDFs (one of the intermediate files 62) that contain the complete specification of the components that make up specific user interfaces. This includes the definition of the widgets that need to be created and the platform specific functionality that they bind to. Chimera 46 employs dynamic binding mechanisms to tie together the GUI to the rest of the device platform. The CDF also contains references to graphics, fonts and other resources that are provided to the runtime engine by Chimera file stream. This promotes modularity and allows each of these components (graphics, fonts, sound, etc.) to be changed independently of each other. In one embodiment, an x86/Win32 form of Chimera is used by UiMagi tool as an emulator and debugger for interfaces.

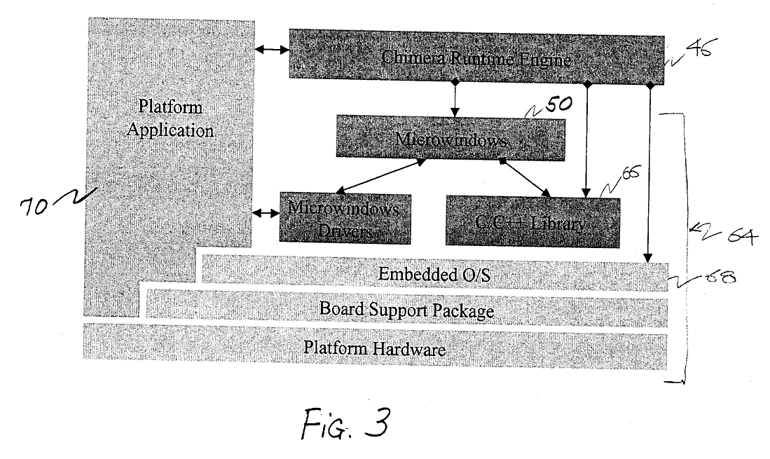

In one embodiment, Chimera 46 uses layered software modules 64 as shown in FIG. 3. Chimera 46 is dependant on standard modules which are easily portable. Further the engine can be easily integrated into the platform application that provides the core platform functionality. The key technologies used by Chimera are a window management engine 50, such as Microwindows used to manage the interaction of widgets. Standard runtime libraries 66 such as C/C+ or Java are used for string manipulation, containers and data structure handling. Chimera 46 is ported to each hardware/operating system platform that it is be deployed on. A small amount of code in the runtime engine created during this porting process will directly use the services of the underlying operating system to implement input/output functionality. Chimera is designed to isolate the platform specific portions so that this porting effort is minimal. The runtime engine itself is designed to be run as a single task created by the platform application 70.

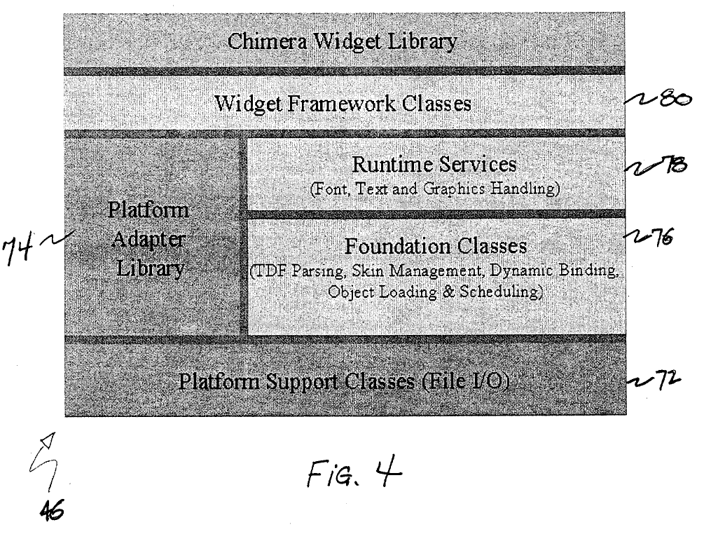

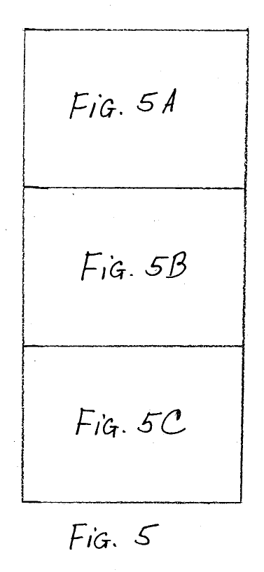

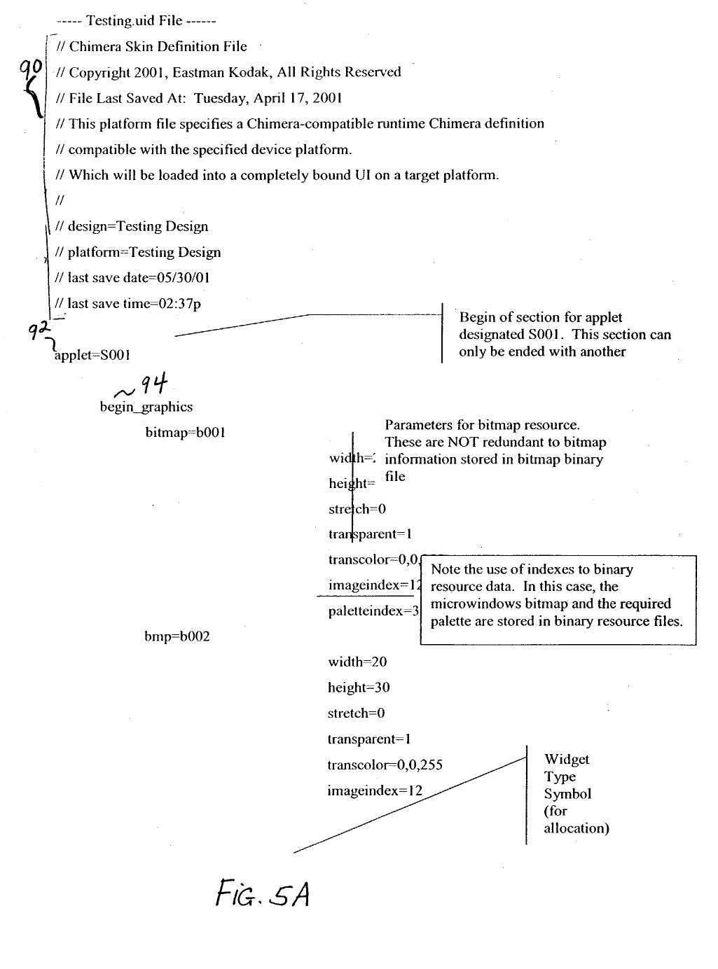

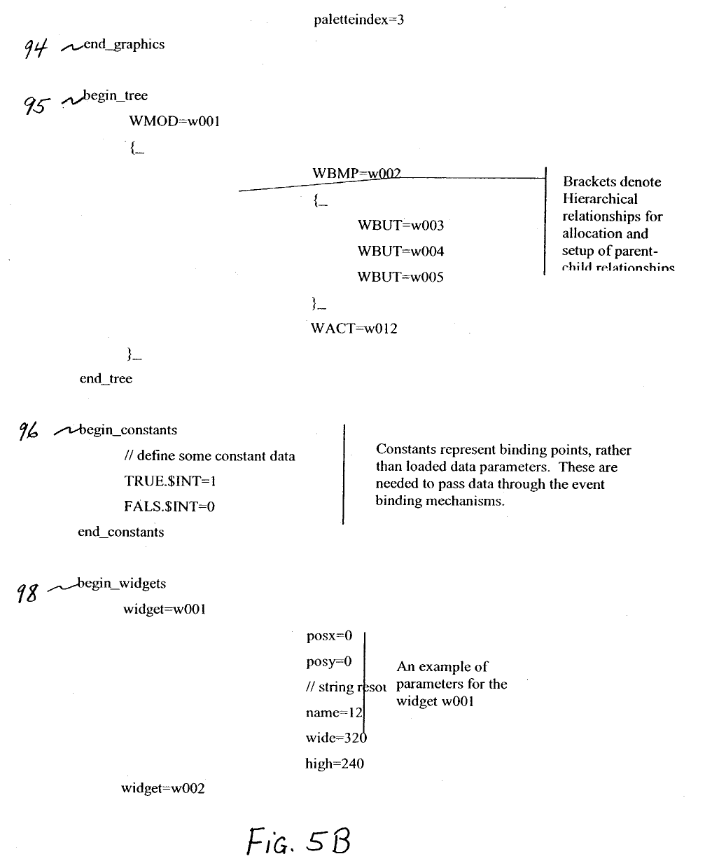

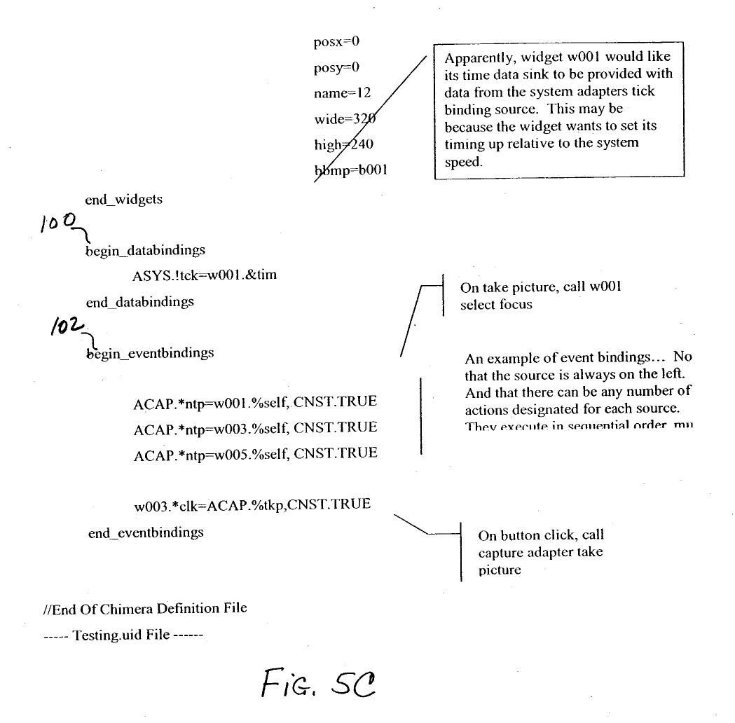

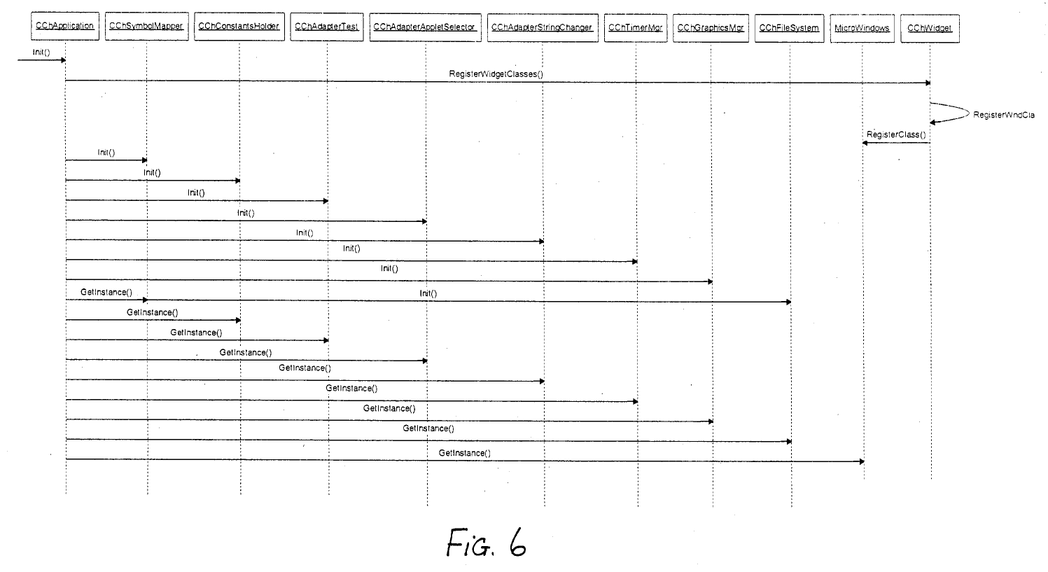

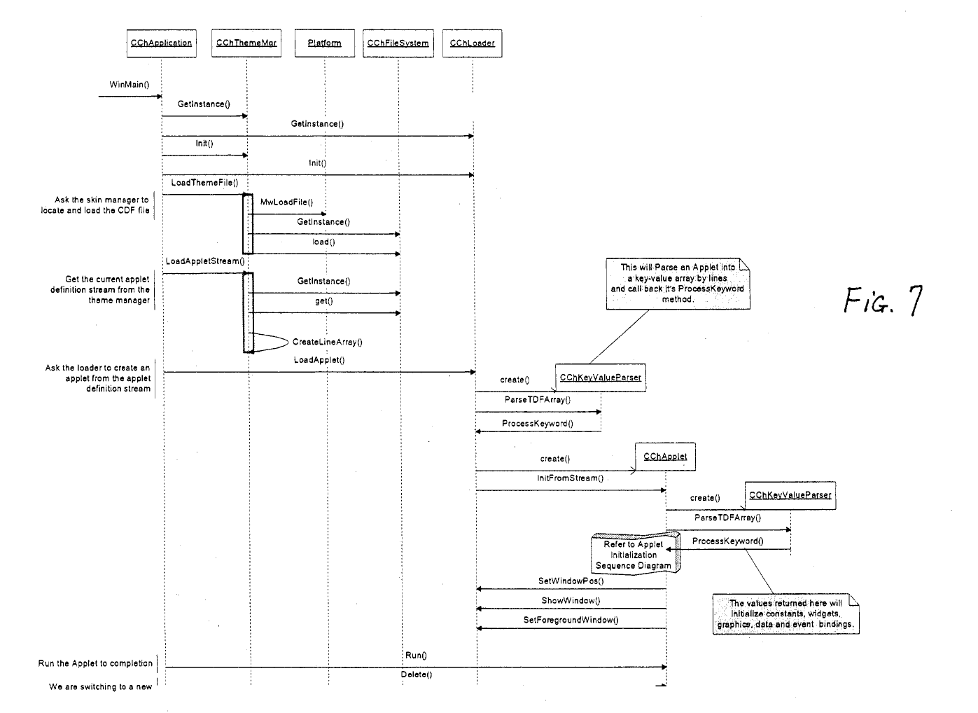

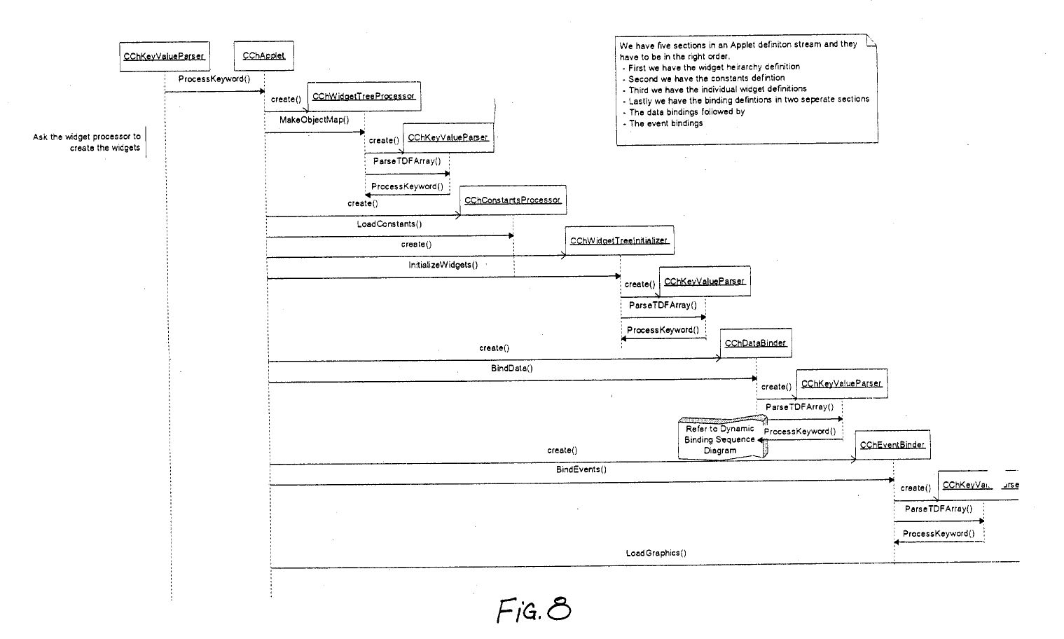

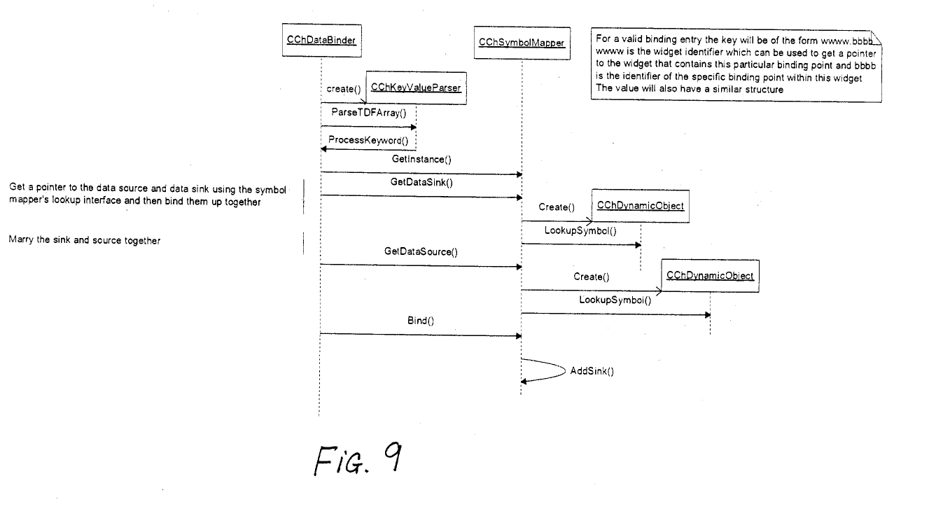

As shown in FIG. 4, the runtime engine 46 can be logically divided into several components each of which adds distinct and coherent functionality. The platform support classes 72 isolate the rest of the engine from the specifics of the underlying platform. These classes are tailored to a specific platform and are not reusable across platforms. Similar to these classes the platform adapter library 74 is a set of classes and routines that bind the engine to the platform application. These classes may have a lot in common across platforms particularly for a family of devices, however, they are closely tied to the interfaces provided by the platform application.

The core of the runtime, which is highly portable and completely reusable, consists of Chimera foundation classes 76 and runtime services 78. These provide the bulk of the functionality of the engine including the dynamic creation and binding of user interface widgets. Chimera also contains widget framework classes 80 that provide an object-oriented interface to the API provided by the window management system 50 (see FIG. 2). The Widget library contains the set of widgets that can be used by the GUI designer to create the product GUI, and mirror the platform specified in the platform file provided for use by UiMagi.

The first step in creating a GUI using UiMagi is to define the platform definition files 60 (see FIG. 2) on which the Chimera runtime engine 46 will be ported. UiMagi 40, as the design tool, uses this definition to impose constraints on the GUIs designed for the defined platform 60. Over time, platforms may support new functionality, which will then appear in UiMagi through the updated platform files. Embedded developers should not change existing functionality, if possible, after GUIs have been designed, to minimize rework of existing GUIs to comply with the platform functionality. The PDL is a combination of keywords used in conjunction with a file layout definition.

Appendix B contains a detailed description of the PDL. The PDL uses the following elements: type designators; enumerators; parameter sets; data binding; event binding; widgets and adapters. Type designators include simple types for atomic data type definitions for runtime parser and binding mechanisms and parameter sets. Enumerations include platform specific value sets backed by simple types. Parameter sets are sets of types used in transferring data through event sink mechanisms. Data binding include data sources and data sinks. Data sinks can be bound to a static source of the type designated or to a data source available on the platform of the specified type. Event binding includes event sources which can be bound to multiple event sinks of any syntax, to perform N operations in a scripted manner and event sinks. An event sink is an operation which can be called from any event source and which will receive a parameter set specified by the type designated. Widgets are abstract class definitions depicting all symbols contained within a widget classes, their types, default values if desired and/or comments. All widget binding points (data/event) are exposed to the GUI designer.

Chimera Definition Language (CDL) defines the structure of the information that is used by the runtime engine 46 to create a GUI. This intermediate format is similar to syntax used in the platform and design files, but is designed to be small and quickly parsed. As such, unused variables or binding points available at runtime are not called out unless used. Appendix C Table I and Sample I contain a detailed description and implementation of CDL. Chimera loader 48 translates Chimera file system stream 42 into runtime interface(s). A detailed description of Chimera Loading Process is contained in Appendix D.

UiMagi 40 provides the following capabilities: a design editor; a PEM; layout management; graphics rendering; design file management; resource management; compression; WYSIWYG simulation; and dynamic user-interface components. The design editor uses the specified platform file(s) 60 to determine the available symbolic capabilities, which drive the editing process. The PEM 61 renders the design file to the target requirements when the design is complete. This step creates the necessary variations of CDF as required by each platform. Several intermediate files 62 are also created for resources (graphics fonts, strings, sounds) in the manner required for each platform. This allows a GUI to be designed and placed on the platform without any involvement of the embedded developers.

UiMagi 40 provides graphical layout assistance to the designer; palletizes graphics to the desired platform palette; organizes, stores and manages design-specific resources, such as strings, fonts, graphics and audio; compresses individual nodes in Chimera file system or the entire chimera file system if desired. The tool can automatically optimize in order to achieve a desired runtime footprint and can run Chimera in a window from within itself to demonstrate results of a Chimera design. The tool dynamically adapts to expose only widgets available on the target platform. The tool also can create and import sets of widgets as reusable components.

UiMagi 40 uses the PEM 61 to create the design for the desired platform, resulting in a Chimera file system stream 42 containing the following elements in raw or compressed form: compiled CDFs (binary files describing individual interfaces); graphics resource files (binary files containing the indexed graphics (raster window manager 50 compatible bitmap streams) and palettes; font resource files (binary files containing indexed character sets and fonts available to the GUI widgets); audio resource files (binary files containing indexed platform-specific audio streams); and string resource files (binary files containing indexed strings available to the GUI widgets).

In order to provide a solution for storing Chimera GUI widgets, CDF, strings, fonts, audio and bitmaps in a platform independent manner as well as a memory independent manner (DISK, ROM, FLASH, or RAM), a simple stream structure 42 was chosen. This can be included as a static variable or pointer to a memory mapped file depending on the platforms resources.

The file structure requires each file to be designated by a name (e.g. ASCII, not Unicode) and size (in little endian format). On initialization a positional index or hash will be created. A primary requirement is to keep all data words (4 bytes) aligned. An end of file stream designation is required and is the same size as the filename, filesize structure. UiMagi automatically generates this file structure. Both a C++ source file and a data file are generated, so embedded developers can use the one that best suits their platforms needs. To provide more flexibility in design, a 4-byte attribute field may be added that will designate files as nested directories and identify the files compression method

A graphical user interface is created by first creating a PDF 60. Next, the GUI skeleton is established as part of product requirements and early human factors work. The simpletypes needed are then defined. Most platforms will reuse several existing simpletypes, such as integer, Boolean, string. In addition, it is likely that various “custom”,simpletypes may exist, such as thumbnails, imagelists, songlists, song. As the GUI development progresses, this may be broken down into more common types and/or a custom type, depending on whether combinations of reusable widget classes can achieve the GUI presentation goals without creating a custom widget class. Beyond simple types, enumerations will include sets of values present on the platform.

The device platform which consists of any number of platform adapters 74 (see FIG. 4) are defined. Platform adapters may be divided by function or even overlap in functionality if desired. Some example adapters might be: storage, capture, processing, system. Adapter concepts may be leveraged from previous Chimera platforms. The embedded system can be defined as a list of data that is available for read and/or write access, as well as methods that can be called to perform functions. In the case of a list of data, the datatype must be determined. In the case of methods (event sinks) available in adapters, the function prototypes should be developed.

Next widget classes are defined. Previous widget classes can be reused, but not all widget classes may be required to accomplish the desired interface goals for the platform. It is up to the embedded developer to decide how many widgets will be made available on the platform, and what custom widgets will exist in the platform.

UiMagi is used to create desired interface interaction. This can be done in parallel with the porting steps. The window management engine 50 is then ported to the device platform 44, including providing drivers 54 for the window management engine 50 which include access to display buffer, as well as standard button events. Chimera loader 48 can be ported from a previous runtime platform. Finally platform adapters 56 are implement to provide the desired data and event binding points specified in the PDFs.

[image]

[image]

[image]

[image]

[image]

[image]

[image]

[image]

[image]

[image]

[image]

[image]

[image]

What is claimed is:

1. A system for creating a graphical user interface for a platform having a display and one or more operator input devices, comprising:
a) a UiMagi for producing a file system stream describing the user interface and resources, UiMagi including
i) a platform definition defining the capabilities of the platform including descriptions of user interface widgets and platform adapters,
ii) a plurality of resources containing descriptions of graphical components used by the widgets,
iii) a layout manager for producing a description of a layout of user interface widgets on the graphical user interface,
iv) a design editor for producing a description of the characteristics of the user interface widgets defined by the layout manager and the resources and how widgets bind with each other and with the platform adapters, the binding involving binding data representations within a widget to a data representation in another widget or adapter, and binding events within a widget to events within another widget or adapter, and
v) a platform export module for creating the file system stream using the descriptions from the layout manager and the design editor and the graphical components from the resources; and
b) a runtime engine located in the platform for rendering the graphical user interface from the file system stream, the runtime engine including:
i) a loader for receiving the file stream and creating the widgets and the adapters needed to produce the graphical user interface and binding the widgets to each other ant to the platform adapters, and
ii) a window management engine for passing input from the operator input devices to the widgets.

2. The system claimed in claim 1, wherein the platform is a digital camera.

3. A method for creating a graphical user interface for a platform having a display and one or more operator input devices, comprising the steps of:
a) providing a UiMagi for producing a file system stream describing the user interface and resources, UiMagi including
i) a platform definition defining the capabilities of the platform including descriptions of user interface widgets and platform adapters,
ii) a plurality of resources containing descriptions of graphical components used by the widgets,
iii) a layout manager for producing a description of a layout of user interface widgets on the graphical user interface,
iv) a design editor for producing a description of the characteristics of the user interface widgets defined by the layout manager and the resources and how widgets bind with each other and with the platform adapters, the binding involving binding data representations within a widget to a data representation in another widget or adapter, and binding events within a widget to events within another widget or adapter, and
v) a platform export module for creating the file system stream using the descriptions from the layout manager and the design editor and the graphical components from the resources;
b) providing a runtime engine located in the platform for rendering the graphical user interface from the file system stream, the runtime engine including:
i) a loader for receiving the file stream and creating the widgets and the adapters needed to produce the graphical user interface and binding the widgets to each other ant to the platform adapters, and
ii) a window management engine for passing input from the operator input devices to the widgets; and
c) designing the graphical user interface on UiMagi and displaying the graphical user interface using the runtime engine.

4. The method claimed in claim 3, wherein the platform is a digital camera.
